(19) United States
(12) Patent Application Publication
(10) Pub. No.: US 2011/0066470 A1
(43) Pub. Date: Mar. 17, 2011

(54) SYSTEM AND METHOD FOR PROVIDING CONTEXT BASED REMOTE ADVISOR CAPABILITIES TO USERS OF WEB APPLICATIONS

(76) Inventors: Vikas Goyal, Bangalore (IN); Deepak Narayan Hoshing, Bangalore (IN)

(21) Appl. No.: 12/614,951

(22) Filed: Nov. 9, 2009

(30) Foreign Application Priority Data
Sep. 14, 2009 (IN) 2223/CHE/2009

(51) Int. Cl. G06Q 10/00; G06F 15/16; G06F 3/048

(52) U.S. Cl. 705/9; 709/205; 715/753; 709/206

(57) ABSTRACT

A method and system for providing context based remote advisor capabilities to users of web applications is provided. The method includes request for access to a live advisor by a user accessing a web application on an electronic communication device. The method further includes determining category of access of the web application. Thereafter, the method includes sending the access request through a server infrastructure to one or more advisor applications used by one or more advisors. The one or more advisor applications are executed on one or more electronic communication devices located remote to the electronic communication device used by the user. A communication session is then established between the advisor executing an advisor application with the user wherein real-time context information of the accessed web application is communicated to the advisor application.

### FIELD OF INVENTION

The present invention is directed towards web applications. More particularly, the present invention provides real-time context based remote advisor capabilities to users of web-based applications.

### BACKGROUND OF THE INVENTION

With advances in web and communication technologies, web-based applications are increasingly being used by businesses as well as individuals for facilitating electronic communication and for availing various commercial services. Web applications most commonly used include webmail, e-commerce, online customer service, online auctions etc. Access to a web application requires a typical user to have access to a web-enabled electronic communication device. A user can easily access a web application by opening a web browser on an electronic device and connecting to a network such as the Internet or an intranet.

Due to increase in dependency on various web applications there is now a constant demand to provide real-time communication between businesses and individuals in different parts of the world. An increasing number of personal and business needs involve real time communication between users of electronic devices. A user might want to communicate in real time with friends or colleagues who are located in a different city or a different country. A real-time communication need for a business may be a meeting required between employees of an organization located in different geographical regions. Such real time communication needs have been met with the use of web applications such as instant messaging, online chat, web conferencing services etc.

Instant messaging between individuals is facilitated by the use of instant messaging tools installed in web-enabled electronic communication devices. A user of such an electronic device can connect to the Internet and share messages and content like audio/video, electronic files etc. with another user using instant messaging tools. For realizing real-time communication needs for a business, enterprise web conferencing tools for conducting live meetings, live presentations and training sessions, collaborative browsing, desktop sharing are frequently used. However, currently used web applications do not have a provision for communicating context of the web application being used in real-time by a user.

In a typical scenario, a user of an application may need advice related to a category while using a web application. For example, a user of a web-based banking application installed in a kiosk may need easy access to a remote advisor for getting real-time information related to a category of the application. In some cases, the user may need to communicate with a remote advisor in real time in order to get some queries answered. Currently used web based technologies do not keep a context in real-time of what a user is working on in a web application. Hence, they do not facilitate selection and provision of an appropriate advisor skilled in answering queries for a user. In an instance, if a user wants to communicate using audio/video with an advisor, he/she has to specifically set up an audio/video session by using directory lookup or searching for a right Internet Protocol (IP) address. In another instance, if a user speaks a particular language, he/she has to manually select and set up a session with an advisor who is conversant in that language. Further, current technologies do not provide a facility for advisors to know the number of users and profile of users needing real-time advice, which may be useful in providing a right kind of advisor to a user seeking information. The above disadvantages may be overcome by real-time determination of context of a user application accessed by a user.

In view of the above, there exists a need for a system and method for determining in real time, context of use of a web application by a user. Further, the system should automatically be able to select a suitable advisor for the user based on the context of use. Additionally, the system should be able to provide the user with access to advisor using audio/video technologies and instant messaging.

### SUMMARY OF THE INVENTION

A method and system for providing context based remote advisor capabilities to users of web applications is provided. In an embodiment of the present invention, while a user is accessing a web application, real time context of the web application is communicated to a remote advisor.

In various embodiments of the present invention, the method includes requesting access to an advisor by a user of a web application. The access request includes request for real-time communication with an advisor. Firstly, the method includes determining category of access of web application. Thereafter, the method includes sending the access request through server infrastructure to one or more advisor applications used by one or more advisors. The one or more advisor applications are executed on one or more electronic communication devices located remote to the first electronic communication device. Subsequently, a communication session is initiated by an advisor executing an advisor application with the user. After initiation of the communication session, context information is shared between the web application and the advisor application. The context information is shared for providing real-time advice to the user by the advisor.

In an embodiment of the present invention, category of access of web application is derived by a software application executed on the electronic communication device used by the user to access the web application. The category of access is determined by matching at least one of uniform resource locator address and content of current web page accessed by the user with a repository of standard phrases.

In an embodiment of the present invention, Microsoft Unified Communication infrastructure is used to send the access request to an appropriate advisor based on the determined category of access.

In an embodiment of the present invention, the request for access to an advisor sent through server infrastructure in inserted in a queue of one or more access requests based on a calculated priority score prior to initiating the communication session by the advisor. The queue of one or more access requests are arranged in descending order of priority by the advisor application.

In another embodiment of the present invention, the priority score for the access request is calculated based on class of user requesting access and waiting time of access request. In an example, the advisor application calculates priority scores of the one or more access requests regularly after a predetermined interval of time.

In yet another embodiment of the present invention, for initiating a communication session, the advisor firstly monitors the queue of one or more access requests. Thereafter, the advisor selects an access request based on its priority score.

In yet another embodiment of the present invention, context information between the web application and the advisor application is shared by the following method steps. Initially, a context sharing session is triggered by the user. The user may trigger the context sharing session by clicking on ‘Share Screen’ tab on a displayed page of the web application. The software application executed on the user electronic device divides shared area of user screen into a rectangular grid of cells. Each cell of shared area is then sent to the advisor application in compressed format, if the information has changed since last update. The server allocates memory for each cell of the rectangular grid and then updates contents of each cell on advisor screen in real time for sharing context information.

In an embodiment of the present invention, the web application accessed by the user is written using a markup language. In another embodiment, the web application is written using Hypertext Markup Language.

The present invention illustrates a system for providing context based real-time remote advice to users of a web application. The system includes a user application configured to share context of the web application with an advisor application. Communication between the user application and the advisor application is facilitated by a server infrastructure. Once, a session is initiated between the user application and the advisor application, the advisor application interacts with the user application to provide advice to user of the user application.

In an embodiment of the present invention, the user application of the system of the present invention further includes a web application rendering module, a context sharing client and a category derivation engine. The web application rendering module is configured to render the web application using a web browser of an electronic device used by the user. The context sharing client is a software application configured to determine context of the web application used by the user and the category derivation engine is configured to determine type of web application in use by the user.

In an embodiment of the present invention, the server infrastructure includes a remote advisor engine configured to set up remote advisement connection between the user application and the advisor application. Further, it includes a unified communications server configured to provide communication tools to facilitate communication between user of the user application and advisor of the advisor application. The server infrastructure also includes an audio/video conferencing server configured to provide at least one of audio conferencing and video conferencing between the user application and the advisor application.

In an embodiment of the present invention, the remote advisor engine is further configured to generate session identifiers dynamically for new users accessing the web application. In an exemplary embodiment, the remote advisor engine includes a context sharing engine configured to share cells corresponding to web application with the advisor application.

In an embodiment of the present invention, the communication tools for facilitating communication between the user application and the advisor application includes tools for providing at least one of a VoIP service, an IVR service, an instant messaging service, an email service, a fax service, a file transfer service, a video service and an audio service.

In an embodiment of the present invention, the advisor application includes a web application rendering module configured to render content of web application accessed by the user on an electronic device used by the advisor. The advisor application further includes a context sharing client configured to receive cells corresponding to areas of the application accessed in real-time by the user. The advisor application also includes a queue management engine configured to maintain an active queue of user applications requesting for an advisement session.

### BRIEF DESCRIPTION OF THE ACCOMPANYING DRAWINGS

The present invention is described by way of embodiments illustrated in the accompanying drawings wherein:

FIG. 1 illustrates a system for providing remote advisor capabilities to a user of a web application;

FIG. 2 is a flowchart illustrating a method for enabling context sharing between a user application and an advisor application in order to provide remote advisement to a user of the user application;

FIGS. 3 and 4 depict a flowchart illustrating a method for establishing a session between a user and an advisor;

FIG. 5 depicts a flowchart illustrating queue management by an advisor application;

FIGS. 6, 7 and 8 depict a flowchart illustrating an algorithm used by category derivation engine for determining category of user application accessed by a user; and

FIG. 9 depicts a screenshot of an advisement session between a user and an advisor, in an embodiment of the present invention.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

The present invention would now be discussed in context of embodiments as illustrated in the accompanying drawings.

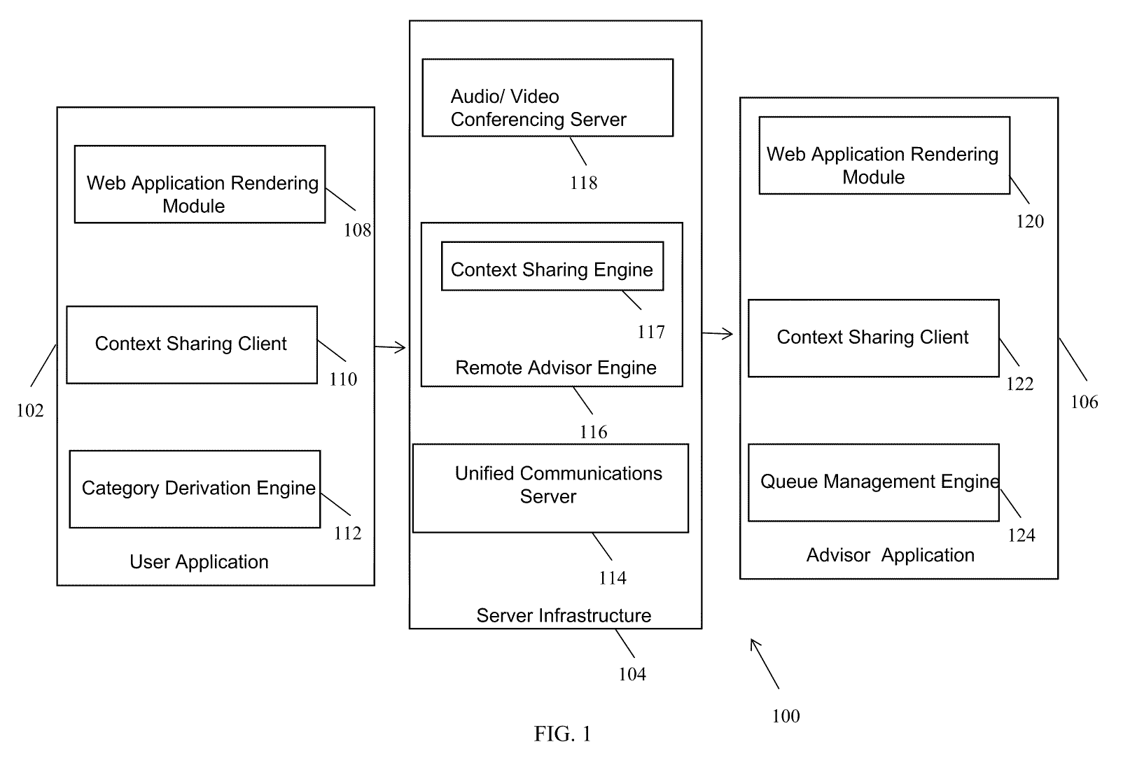

FIG. 1 illustrates a system 100 for providing remote advisor capabilities to a user of a web application. In various embodiments of the present invention, the system 100 includes a user application 102, a server infrastructure 104 and an advisor application 106. The present invention may be used in scenarios where a user using an electronic application may need access to real time advisement. Examples of such scenarios may be a user accessing a banking application through an ATM machine, a user buying retail merchandise of a popular store online using a web-based connection etc. In the preceding scenarios, a user may require real time advisement while making a decision regarding choosing a particular banking product such as a loan or selecting merchandise.

In various embodiments of the present invention, the system 100 provides a facility for remote advisement which is facilitated by the system elements: the user application 102, the server infrastructure 104 and the advisor application 106. The user application 102 is a software application that is embedded in an electronic device used by the user. In an embodiment of the present invention, a user may log on to a web application through a web browser of the electronic device launched through user application 102. In an example, the electronic device may be a processing device used by the user to make a web based transaction.

The user application 102 comprises a web application rendering module 108, a context sharing client 110 and a category derivation engine 112. The web application rendering module 108 is responsible for rendering the web application using web browser of the electronic device used by the user. An example of a web application includes applications such as a purchase application for a product, a web based subscription, a web based appointment, usage of a web based database or a multimedia application or any web based application that may require advisement before selection of a product or a service. In an embodiment of the present invention, the web application rendering module 108 includes tools for rendering and navigating web documents and web pages related to the web application accessed by the user.

The category derivation engine 112 determines category of the page being viewed by the user. For example, in case of a banking application, categories include bill payment, investment products, savings products, loan products, subscription services, miscellaneous services etc. In an embodiment of the present invention, a category of request is derived by the category derivation engine 112 using the URL or content of web page currently accessed by the user. The category derivation engine 112 derives the category of access by matching the URL and content of web page accessed by the user with standard phrases stored in a repository. In an embodiment of the present invention, the category derived by the category derivation engine 112 is used by other system elements of the system 100 to provide remote advisor capability to the user as described herewith.

The context sharing client 110 within the user application 102 is a software module for determining context and sharing context of web application currently used by the user with the advisor application 106, after a communication session has been established between the user application and the advisor application. In an embodiment of the present invention, context sharing is enabled by the user clicking on “share screen” portion of the user application. This triggers a request sent by the context sharing client 110 to a context sharing engine 117 in the server infrastructure 104 for facilitating context sharing between the user application and the advisor application. In various embodiments of the present invention, the user application divides the shared area into a rectangular grid of (m×n) cells and creates a unique identifier for each cell of the grid. Thereafter, cells corresponding to areas of the application accessed in real-time by the user are compressed and sent to the context sharing client 122 in the advisor application 106.

The system 100 connects the user application 102 to the advisor application 106 used by an advisor to communicate with the user. The advisor application 106 interacts with the user application 102 through the server infrastructure 104. The advisor application 106 may be embedded in an electronic device used by an employee of an enterprise selected to provide counseling or advice regarding a business product or service. Example of an enterprise may include a bank, a retail store, an educational institution, a service provider or any business/organization providing a remote online purchase facility to its customers. In various embodiments of the present invention, an organization may have multiple advisors running advisor applications on their respective electronic devices and a particular advisor is selected from the list of multiple advisors to provide advice based on the type and category of application accessed by the user and the availability and expertise of advisors.

The server infrastructure 104 includes a unified communications server 114, a remote advisor engine 116 and an audio/video conferencing server 118. The unified communications server 114 includes one or more integrated servers for providing communication tools to facilitate communication between the user of the user application 102 and the advisor using the advisor application 106. Communication tools provided by the server infrastructure 104 include tools for providing services such as Voice over Internet Protocol (VoIP), instant messaging, email, file transfer services, video and voice calling service etc. In an exemplary embodiment, the server infrastructure may be a Microsoft Unified Communications Server that may provide one or more following services between the user application and the advisor application: voice and video calling service, presence information, instant messaging, streaming multimedia, audio conferencing, video conferencing and web conferencing. The remote advisor engine 116 is responsible for setting up remote advisement connection between the user application 102 and the advisor application 106. In various embodiments of the present invention, the remote advisor engine 116 creates unique session identifiers for users utilizing the user application for obtaining help of a remote advisor. In an example, the remote advisor engine 116 creates a session identifier dynamically for each new user accessing the user application 102. A remote advisement session is then set up between user of the user application 102 and the advisor using the advisor application 106. The remote advisement session is set up using category of web application derived by the category derivation engine 112 in the user application 102. In an embodiment of the present invention, the user may request for assistance from an advisor. Based on the category of web application derived from the category derivation engine 112, the remote advisor engine 116 initiates contact with an “appropriate” advisor using the advisor application 106. In an example, a user may access “Bill pay” category within a banking application in ‘French’ language. In this example, the remote advisor engine 116 initiates contact with an advisor skilled in providing advice in ‘French’ language related to the “Bill pay” category. The remote advisor engine 116 further comprises a context sharing engine 117. The context sharing engine 117 utilizes compressed cell information of web-based application transmitted by the by the context sharing client 110 to the server infrastructure 104 and in turn provides real time context of the web application to the advisor application 106.

The advisor application 106 includes a web application rendering module 120, a context sharing client 122 and a queue management engine 124. The web application rendering module 120 is adapted to render content of web application accessed by the user on the electronic device used by an advisor. The context sharing client 122 of the advisor application 106 shares context data with the user application 102, so that the advisor using the advisor application 106 is aware of the information accessed by the user in real-time. Thus, the advisor uses the current context to communicate in real-time with the user and provide valuable advice. In an embodiment of the present invention, the queue management engine 124 maintains an active queue of users requesting for an advisement session. Each user in the queue is assigned a priority score based on the type of user. Examples of type of user includes a gold class user, a silver class user etc. In an embodiment of the present invention, an advisor initiates communication with a user with the highest score. In another embodiment of the present invention, the system may reject a request for communication with a user if the queue maintained has reached its maximum capacity.

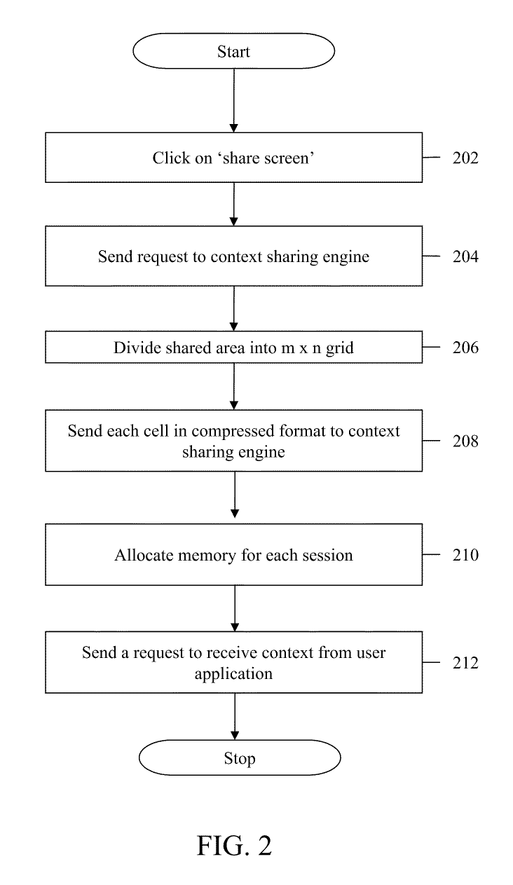

FIG. 2 is a flowchart illustrating a method for enabling context sharing between a user application and an advisor application in order to provide remote advisement to a user of the user application. In an embodiment of the present invention, for providing remote advisement to user of a web application, the advisor of the web application has to be made aware of the context of the application in use.

In various embodiments of the present invention, context sharing between the user application and the advisor application is implemented by the following steps: At step 202, a user of the web application clicks on ‘Share Screen’ portion of the application. This triggers a request sent to a context sharing engine in the server infrastructure for facilitating context sharing between the user application and the advisor application, at step 204. Thereafter, at step 206, the user application divides the shared area into a rectangular grid of (m×n) cells and creates a unique identifier for each cell of the grid. By creating a unique identifier for each cell of the grid, it becomes possible to keep track of parts of the screen accessed by the user and providing this context information to the advisor application. In an embodiment of the present invention, the dimensions of the grid are configurable. At step 208, cells corresponding to areas of the application accessed by the user are compressed and sent to the context sharing engine. For example, with respect to a banking application, if a user accesses ‘personal loan’ option of the menu loans, the cells corresponding to this screen are sent to the context sharing engine. In an embodiment of the present invention, the cells transmitted in compressed format are sent or received only if the cells have changed since the last time they were sent. Upon receiving cells in compressed format, at step 210, the context sharing application allocates memory for each cell and for each session. In an embodiment of the present invention, the context sharing application updates contents of cells received from the user application. Thus, the context sharing engine allows user and advisor to share application screens with each other. At step 212, the advisor application sends a request to receive context from the user application.

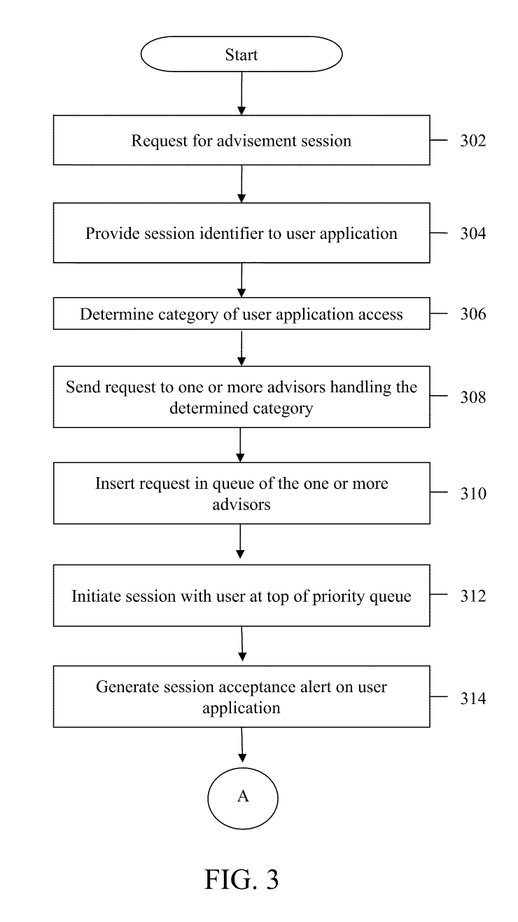

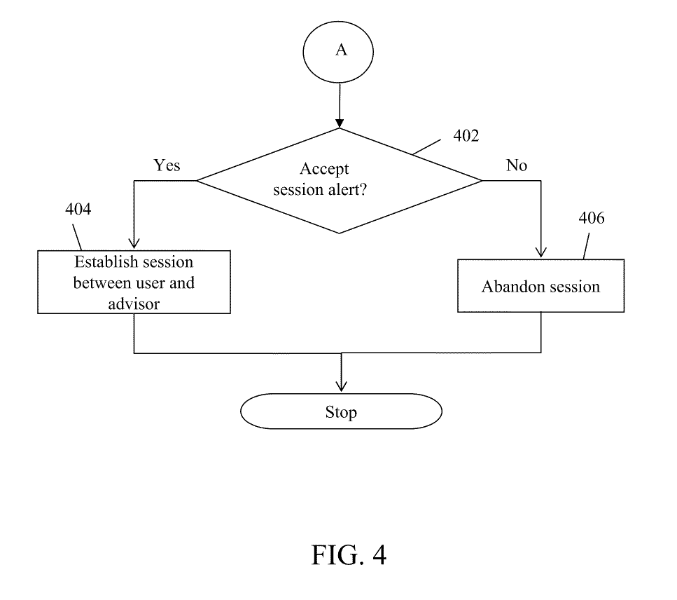

FIGS. 3 and 4 depict a flowchart illustrating a method for establishing a session between a user and an advisor. In an embodiment of the present invention, at step 302, a request for an advisement session is sent by a user using a web application to a unified communications server. A session identifier is generated dynamically by a remote advisor engine for the requested session and is provided to the user application. Thereafter, at step 306, category of web application currently accessed by the user is determined by category derivation engine. The determined category is then employed to provide advisor access to user of the user application. In an example, the determined category may be a user accessing a “Demat account” within investment banking application in French language and the advisor may be a person skilled in online trading and “French” language. At step 308, one or more advisors handling the determined category are selected by the remote advisor engine and session request is sent to them.

Each advisor application has a queue of user requests waiting for assistance. At step 310, session request is inserted in queue of the one or more advisors handling the determined category. Each user request in the queue is assigned a priority score based on its class. At step 312, one of the advisors from the one or more advisors initiates a session with the user of the user application on the top of priority queue. The advisor application refreshes priority queue at predetermined intervals of time before selecting a user at top of the priority queue. In an embodiment of the present invention, queue management engine does not add the request to advisor queue if the advisor is not eligible to service this request based on category and language. Upon initiation of session by the advisor, a session acceptance alert gets generated on user application at step 314.

At step 402, the user application makes a decision regarding accepting the session. In an embodiment of the present invention, the user refrains from accepting the session if, while waiting for session acceptance alert, information required by the user is obtained by browsing the web application. If the user accepts the session, then at step 404, a session is established between the user and advisor. However, if the user does not accept the session alert, the session is abandoned at step 406.

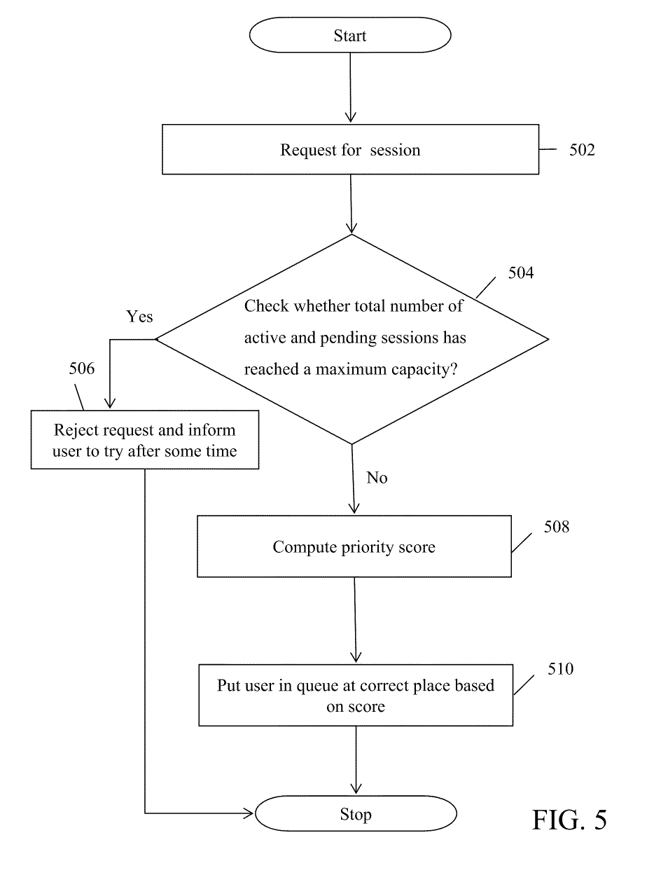

FIG. 5 depicts a flowchart illustrating queue management by an advisor application. In an embodiment of the present invention, when a user requests for a session with an advisor, the request is inserted in queues of user requests of one or more selected advisors. The method steps involved in inserting a session request in queue of user requests is illustrated in the flowchart of FIG. 5. At step 502, a user requests for a session with an advisor. At step 504, queue management engine in the advisor application checks whether total number of active and pending sessions has reached a maximum capacity. If maximum capacity has been reached, at step 506 the session request is rejected by the advisor application and the user is informed by the advisor application to try connecting after a predetermined interval of time.

If maximum capacity has not been reached, at step 508, a priority score is calculated by the advisor application for the user waiting for an acceptance of user request. In an embodiment of the present invention, the priority score is calculated as follows:

Primarily, for calculating priority score for a user, weightages are assigned to user class and waiting time. Firstly, an initial priority score is calculated for each user taking into account class of user accessing user application. A user class number (c) is a number assigned to class of user based on customer status. In an example, let the user class number (c) for a user A be 10 and for a user B be 1. If weightage (wc) assigned to user class is 100, then the initial priority score for user A is calculated by (class number)×(weightage)=c×wC=10×100=1000. Similarly, the initial priority score for user B=c×wc=1×100=100.

As users are waiting for acceptance of session request upon sending session requests, updated priority scores are calculated for each user taking into account waiting time (t) of user. Waiting time (t) is time period for which user is waiting for acceptance of a session request. After a refresh interval of 5 sec, assuming that the wait times for user A and user B respectively are 5 and 10 secs. In this scenario, the updated scores are calculated using the formula: Current score=(Initial score+t×wt) where t is waiting time of user and wt is weightage assigned to waiting time. Let the weightage assigned to waiting time be 50. For user A, the updated score is 1000+(5×50)=1250 and for user B, the updated score is 100+(10×50)=600.

After calculating priority scores for the user, at step 510, the user is put in its correct place in the queue, where the queue is arranged such that user with highest priority score gets the highest priority in the queue. In an embodiment of the present invention, priority scores of users are updated at regular intervals of time and the queue is refreshed in descending order of priority score.

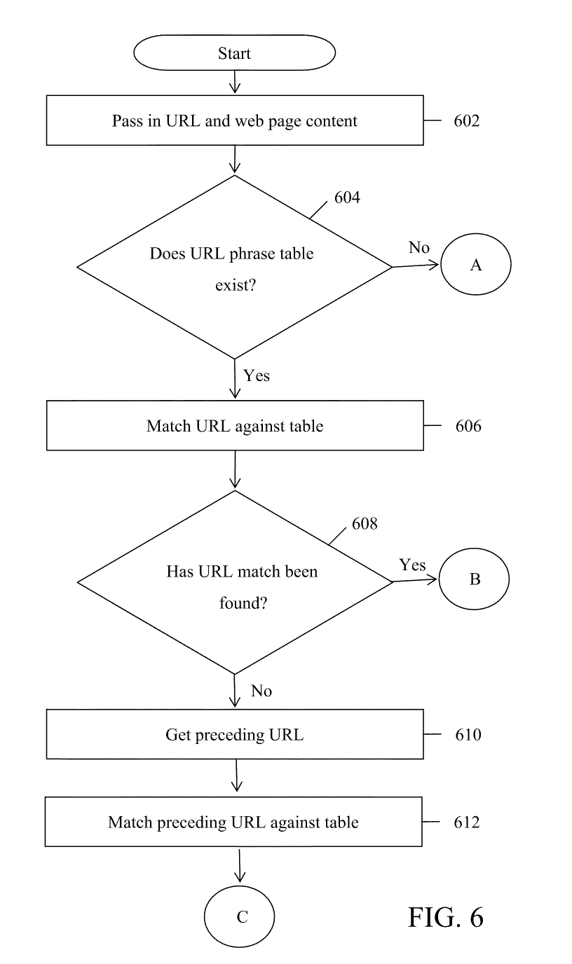

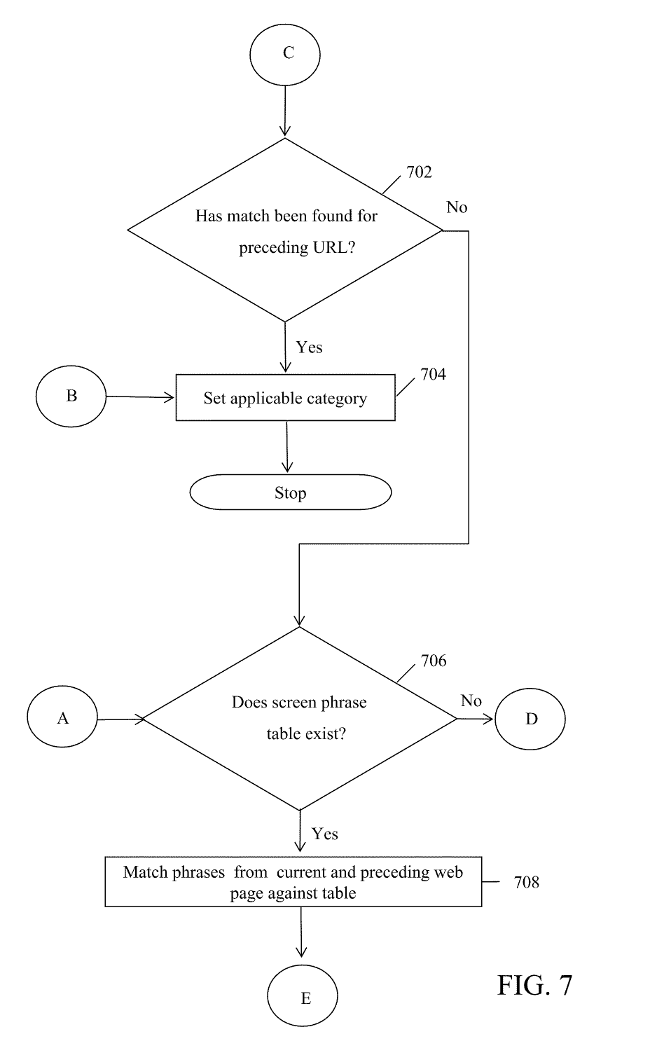

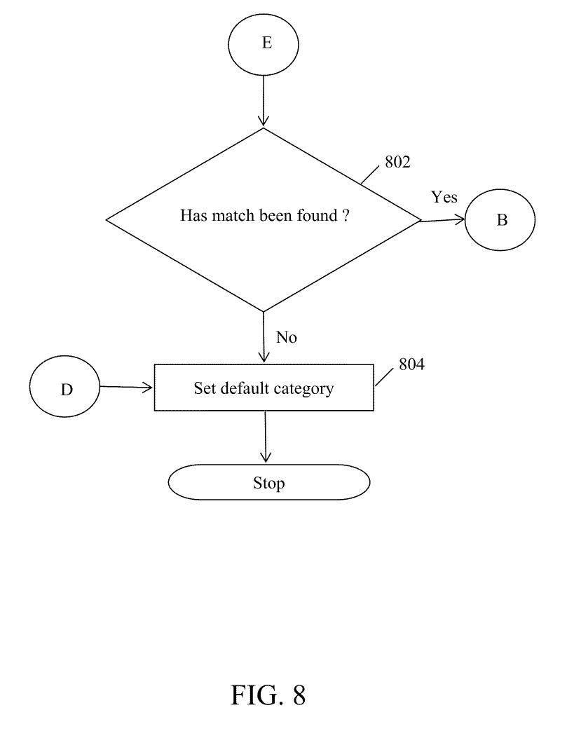

FIGS. 6, 7 and 8 depict a flowchart illustrating an algorithm used by category derivation engine for determining category of user application accessed by a user. In an embodiment of the present invention, while a user is browsing a web application, he may need advice related to certain category of the application. For determining the category of access, the following method steps are used:

At step 602, current Uniform Resource Locator (URL) or web address of the web page accessed by the user application as well as content of web page is passed to category derivation engine. At step 604 it is determined whether a URL phrase table exists in the category derivation engine. A URL phrase table is table containing phrases obtained from the URL matched with categories related to a specific application. An example of a URL category phrase table is as follows:

| Phrases | Category |
|---|---|
| Deposit.jsp | Deposit |
| Payment.jsp | Bill Pay |

If it is determined at step 604 that a URL category phrase table exists, then at step 606, phrases from the table are matched with the current URL. If a match is found, then at step 704, an applicable category is set. In an embodiment of the present invention, the set category is then provided to a remote advisor engine for further processing. However, at step 608, if it is determined that no match for the phrases is found then the flow proceeds to step 610 where a preceding URL accessed by the user is obtained from the user application and at step 612, the preceding URL is used to obtain a match from the URL category phrase table. If a match is found for preceding URL, then at step 704, an applicable category is set.

In an embodiment of the present invention, if at step 604 it is determined that the URL category phrase table does not exist or at step 702, a match for preceding URL is not found, then the flow is transferred to step 706, where it is determined whether a screen phrases category map table exists. A screen phrases category map table is table containing phrases obtained from current web page accessed by the user application matched with categories related to a specific application. An example of a screen phrases category map table is as follows:

| Phrases | Category |
|---|---|
| Pay my bill | Bill Pay |
| Operative account | CASA |

At step 708, phrases from current web page are matched using the screen phrases category map table. If no match is found, then phrases from a preceding page accessed by the user are matched.

If it is determined at step 802 that a match is found either for the current page or the preceding page, the applicable category is set. However if no match is found, then at step 804 a ‘default’ category is set.

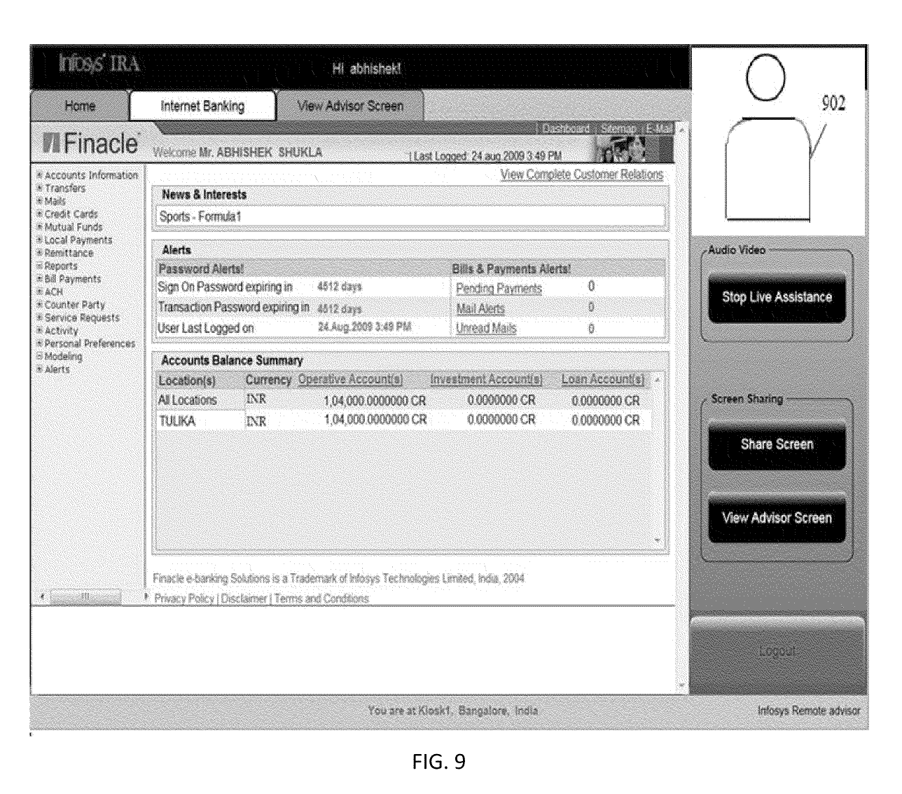

FIG. 9 depicts a screenshot of an advisement session between a user and an advisor, in an embodiment of the present invention. As shown on the top right corner in the figure, an advisor 902 provides real time advice to the user who can also access his account information. In an embodiment of the present invention, by clicking on “Share Screen” context information related to use of the web application by the user is shared with the advisor.

The present invention may be implemented in numerous ways including as a system, a method, or a computer readable medium such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A method for providing context based remote advisor capabilities to a user accessing a web application by a software application executed on a first electronic communication device, the method comprising the steps of:
requesting access to an advisor by the user, wherein the access request comprises request for real-time communication with an advisor;
determining category of access of web application;
sending the access request through server infrastructure to one or more advisor applications used by one or more advisors, wherein the one or more advisor applications are executed on one or more electronic communication devices located remote to the first electronic communication device;
initiating a communication session by an advisor executing an advisor application with the user; and
sharing context information between the web application and the advisor application, wherein the context information is shared for providing real-time advice to the user by the advisor.

2. The method of claim 1, wherein category of access of web application is determined by matching at least one of uniform resource locator address and content of current web page accessed by the user with a repository of standard phrases to derive the category of access.

3. The method of claim 1, wherein the access request is sent to the one or more advisor applications based on the determined category of access using Microsoft Unified Communication infrastructure.

4. The method of claim 1 further comprising inserting the access request in a queue of one or more access requests based on a calculated priority score prior to initiating the communication session by the advisor, wherein the queue of one or more access requests are arranged in descending order of priority by the advisor application.

5. The method of claim 4, wherein the priority score for the access request is calculated based on class of user requesting access and waiting time of access request.

6. The method of claim 5, wherein the advisor application calculates priority scores of the one or more access requests regularly after a predetermined interval of time.

7. The method of claim 6, wherein initiating a communication session by the advisor comprises:
monitoring the queue of one or more access requests; and
selecting the access request based on its priority score.

8. The method of claim 1, wherein sharing context information between the web application and the advisor application comprises:
triggering a context sharing session by the user;
dividing shared area of user screen into a rectangular grid of cells;
sending each cell of shared area to the advisor application in compressed format, if the information has changed since last update;
allocating memory for each cell of the rectangular grid at the server; and
updating contents of each cell on advisor screen in real time for sharing context information.

9. The method of claim 1, wherein the web application is written using a markup language.

10. The method of claim 1, wherein the web application is written using Hypertext Markup Language.

11. A system for providing context based remote advisor capabilities to a user accessing a web application, the system comprising:
a user application configured to share context of the web application with an advisor application;
a server infrastructure configured to facilitate communication between the user application and the advisor application; and
an advisor application configured to interact with the user application, wherein the advisor application is used by an advisor to provide advice to user of the user application.

12. The system of claim 11, wherein the user application comprises:
a web application rendering module configured to render the web application using a web browser of an electronic device used by the user;
a context sharing client configured to determine context of the web application used by the user; and
a category derivation engine configured to determine type of web application in use by the user.

13. The system of claim 11, wherein the server infrastructure comprises:
a remote advisor engine configured to set up remote advisement connection between the user application and the advisor application;
a unified communications server configured to provide communication tools to facilitate communication between user of the user application and advisor of the advisor application; and
an audio/video conferencing server configured to provide at least one of audio conferencing and video conferencing between the user application and the advisor application.

14. The system of claim 13, wherein the remote advisor engine is further configured to generate session identifiers dynamically for new users accessing the web application.

15. The system of claim 14, wherein the remote advisor engine further comprises a context sharing engine, wherein the context sharing engine is configured to share cells corresponding to web application with the advisor application.

16. The system of claim 13 wherein the communication tools comprises tools for providing at least one of a VoIP service, an IVR service, an instant messaging service, an email service, a fax service, a file transfer service, a video service and an audio service.

17. The system of claim 11, wherein the advisor application comprises:
a web application rendering module configured to render content of web application accessed by the user on an electronic device used by the advisor;
a context sharing client configured to receive cells corresponding to areas of the application accessed in real-time by the user; and
a queue management engine configured to maintain an active queue of user applications requesting for an advisement session.

18. A computer program product comprising a computer usable medium having a computer readable program code embodied therein for providing context based remote advisor capabilities to a user accessing a web application by a software application executed on a first electronic communication device, the computer program product comprising:
program instruction means for requesting access to an advisor by the user;
program instruction means for determining category of access of web application;
program instruction means for sending the access request through server infrastructure to one or more advisor applications used by one or more advisors;
program instruction means for initiating a communication session by an advisor executing an advisor application with the user; and
program instruction means for sharing context information between the web application and the advisor application.

19. The computer program product of claim 18 further comprising program instruction means for inserting the access request in a queue of one or more access requests based on a calculated priority score prior to initiating the communication session by the advisor.

20. The computer program product of claim 18, wherein the program instruction means for initiating a communication session by the advisor comprises:
program instruction means for monitoring the queue of one or more access requests; and
program instruction means for selecting the access request based on its priority score.

21. The computer program product of claim 18, wherein the program instruction means for sharing context information between the web application and the advisor application comprises:
program instruction means for triggering a context sharing session by the user;
program instruction means for dividing shared area of user screen into a rectangular grid of cells;
program instruction means for sending each cell of shared area to the advisor application in compressed format;
program instruction means for allocating memory for each cell of the rectangular grid at the server; and
program instruction means for updating contents of each cell on advisor screen in real time for sharing context information.
